(19) United States
(12) Patent Application Publication
(10) Pub. No.: US 2009/0262714 A1
(43) Pub. Date: Oct. 22, 2009

(54) Network gateway and network system for a vehicle

(75) Inventors: Ji Hyun Lim, Gyeonggi-do (KR); Nam Kwon Jung, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/220,869

(22) Filed: Jul. 29, 2008

(30) Foreign Application Priority Data
Apr. 22, 2008 (KR) 10-2008-0037378

(51) Int. Cl. H04B 7/26

(52) U.S. Cl. 370/338

(57) ABSTRACT

The present invention relates to the network gateway for a vehicle and network system in which the mobile device which supports the wireless LAN is able to use the Internet by using the telematics module of a vehicle. For this, the present invention includes an user interface in which a user command is inputted and the process result for the user command is indicated; a telematics module in which a mobile communications network connecter is mounted to be able be connected to Internet that the mobile communications network provides; a mobile device equipped with a wireless LAN; and a network gateway which connects the mobile device to the Internet through the telematics module according to the request of the user interface or the mobile device in the state of being connected to the mobile device through the wireless LAN.

### CROSS-REFERENCE TO RELATED APPLICATION

This application claims under 35 U.S.C. §119(a) the benefit of Korean Patent Application No. KR 10-2008-37378 filed Apr. 22, 2008, the entire contents of which are incorporated herein by reference.

### BACKGROUND OF THE INVENTION

The present invention relates to a network gateway for a vehicle and a network system, and more particularly, to a technology in a vehicle which enables a mobile device which supports a wireless LAN to readily utilize the Internet without an additional apparatus by using a telematics module.

Recently, the number of vehicles with a telematics module have increased in order to improve the stability of a vehicle or the convenience of a driver while the quality of a vehicle is enhanced. The telematics module includes a mobile communications connection module (for example, the Code Division Multiple Access CDMA module) for connecting to the mobile communications network, which enables the vehicle to connect to the wireless Internet (hereinafter, “Internet”) through a mobile communications network. By using the telematics module, a driver can connect to the Internet in the inside of a vehicle to transceive an e-mail or search various information.

The telematics module can report the condition of a vehicle to the driver when a vehicle failure is detected after diagnosing the vehicle at a remote site through a mobile communications network, and can inform the driver of follow-up measures for solving the vehicle failure. The telematics module provides various information including traffic information, living information, and emergency response and rescue information through the Internet.

At present, in a vehicle, the mobile device for supporting a wireless LAN of a fixed location base (for instance, but not limited to, a notebook, a Portable Multimedia Player PMP) cannot connect to the Internet while the vehicle is moving. In order to connect to the Internet while the vehicle is moving, a special protocol that is designed for portability should be installed, or the vehicle should preferably be equipped with a mobile communications network connection module which is connected to the mobile device.

However, a mobile device supporting the wireless LAN corresponding to a system which does not guarantee portability has to be designed for a wireless LAN which can also be portable, since a system or design corresponding to the wireless LAN is fixed in the products production to be put on the market. Further, in case of connecting to the Internet through an additional mobile communications network connection module, consideration should be made for the user to pay an installation fee and a charge for the mobile network connection module.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the invention provides a mobile device on the inside of a vehicle capable of connecting to the Internet without an additional mobile communications connection network module or a protocol in the vehicle equipped with a telematics module.

In one aspect, the present invention is directed to a network gateway for a vehicle, which preferably includes an interface connecter which is connected to a user interface in which a user command is inputted and a process result for the user command is indicated; a telematics module connecter which is suitably connected to a telematics module in which a mobile communications network connecter is mounted; a wireless LAN connecter which is suitably connected to a mobile device equipped with a wireless LAN; and a controller which preferably connects the mobile device to the Internet that the mobile communications network suitably provides through the telematics module when the Internet access of the mobile device is requested from the interface connecter or the wireless LAN connecter.

Preferably, a printed circuit board in which the interface connecter, the telematics module connecter, the wireless LAN connecter, and the controller are designed is suitably installed at the inside of the user interface. In other preferred embodiments, a printed circuit board in which the interface connecter, the telematics module connecter, the wireless LAN connecter, and the controller are designed is suitably installed at the inside of the telematics module. In exemplary embodiments, the controller requests the telematics module to perform the Internet access of the mobile device when the Internet access of the mobile device is suitably requested, while the telematics module preferably transmits an Internet access request message to the mobile communications network under the control of the controller to suitably connect the mobile device to the Internet that the mobile communications network provides. In certain embodiments, the controller preferably requests the telematics module to perform an Internet close of the mobile device when the Internet close of the mobile device is suitably requested, while the telematics module transmits an Internet close request message to the mobile communications network under the control of the controller to disconnect the mobile device to the Internet that the mobile communications network provides.

According to a another aspect of the invention, provided herein is a network system for a vehicle, which suitably includes a user interface which receives a user command and indicates a process result for the user command; a telematics module in which a mobile communications network connecter is suitably mounted to be able be connected to the Internet that the mobile communications network provides; a mobile device equipped with a wireless LAN; and a network gateway which suitably connects the mobile device to an Internet that the mobile communications network provides through the telematics module according to the request of the user interface or the mobile device in the state of being connected to the mobile device through the wireless LAN.

In preferred embodiments, the user interface is one or more display units which are preferably installed at the inside of a vehicle and receive a given command from the user. The mobile device preferably loads a program for performing the Internet access while being linked with the network gateway in the state where the network gateway and the wireless LAN are connected. The network gateway requests the Internet access of the mobile device to the telematics module when the Internet access of the mobile device is requested, while the telematics module suitably transmits an Internet access request message to the mobile communications network under the control of the network gateway to connect the mobile device to the Internet. The network gateway preferably includes an interface connecter which is connected to the user interface; a telematics module connecter which is connected to the telematics module; a wireless LAN connecter which a mobile device is preferably connected to through the wireless LAN; and a controller which connects the mobile device to the Internet that the mobile communications network provides through the telematics module when the Internet access of the mobile device is suitably requested from the interface connecter or the wireless LAN connecter.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a block diagram of the network system of a vehicle according to an embodiment of the present invention.

FIG. 2 is a detailed block diagram of the network gateway illustrated in FIG. 1.

FIG. 3 is a flowchart for illustrating the operation of the network system for a vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DESCRIPTION OF SPECIFIC EMBODIMENTS

As described herein the present invention includes a network gateway for a vehicle, comprising an interface connecter which is connected to an user interface in which a user command is inputted and a process result for the user command is indicated, a telematics module connecter which is connected to a telematics module in which a mobile communications network connecter is mounted, a wireless LAN connecter which is connected to a mobile device equipped with a wireless LAN, and a controller which connects the mobile device to the Internet that the mobile communications network provides through the telematics module.

In preferred embodiments of the invention, the controller connects the mobile device to the Internet that the mobile communications network provides through the telematics module when the Internet access of the mobile device is requested from the interface connecter or the wireless LAN connecter.

The invention can also include a motor vehicle comprising a network system as described herein.

Hereinafter, preferred embodiments of the present invention will be illustrated with reference to the attached drawings.

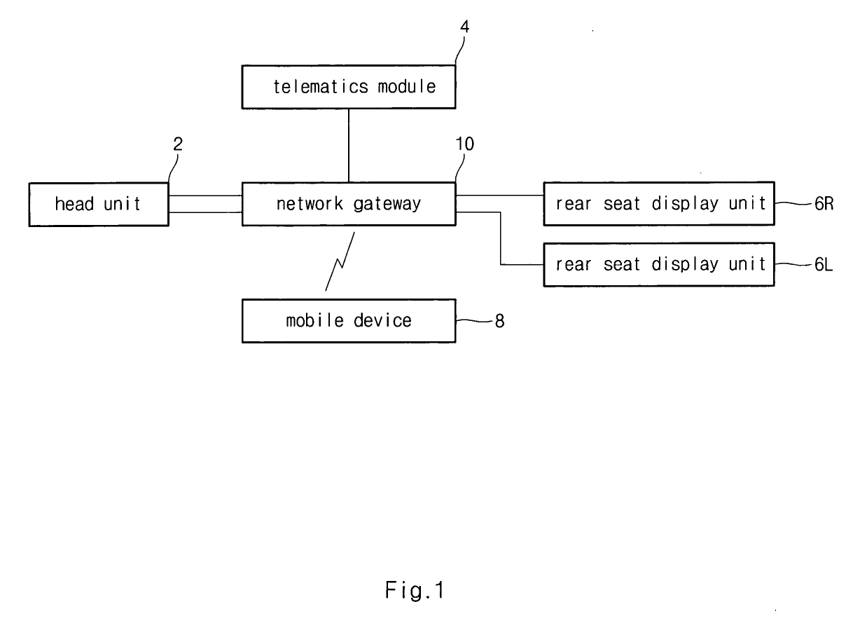

FIG. 1 is a block diagram of the network system of a vehicle according to an embodiment of the present invention.

As shown in exemplary FIG. 1, the network system of a vehicle to which the network gateway for a vehicle according to the embodiment of the present invention is applied preferably includes a head unit 2, a telematics module 4, a rear seat display unit 6R, 6L, and a network gateway 10.

In preferred embodiments, the head unit 2 is a user interface which receives a command from a user and indicates the result of performing the received command. In one embodiment of the present invention, the head unit 2 suitably corresponds to the display unit provided for a front seat passenger. In another embodiment of the present invention, the head unit 2 preferably includes a menu or a button for inputting a command relating to an Internet access of a mobile device. In further preferred embodiments, the head unit 2 of the embodiment of the present invention is implemented with a touch panel.

In exemplary embodiments, the telematics module 4 mounts a mobile communications network connection module (not shown) and connects to a mobile communications network (for example, but not limited to, the CDMA mode, the Global System for Mobile Telecommunication GSM mode, or the 3G (Generation) mode). A user can use the web service provided from the Internet through a telematics module 4, while various telematics services which are generally performed in the relevant industry are suitably provided.

In further exemplary embodiments, the rear seat display unit 6R, 6L are display units suitably provided for the rear seat passenger of a vehicle. In one embodiment of the present invention, the rear seat display unit 6R, 6L can suitably perform the same function as the head unit 2. The rear seat display unit 6R, RL of the embodiment of the present invention may be equipped with a menu or a button for inputting a command relating to the Internet access of the mobile device. In another preferred embodiment of the present invention, the head unit 2 can be implemented with a touch panel. Preferably, the rear seat display unit 6R, 6L may include all display devices installed at the arbitrary location of the inside of the vehicle such as, but not limited to, a monitor installed at the backside surface of the front seat, a center console, or a vehicle roof.

In preferred examples, the network gateway 10 is connected to a mobile device 8 with the wireless LAN (for example, but not limited to, the Wireless Internet Platform for Interoperability WIPI, and so on), and connected to the head unit 2, the telematics module 4, and the rear seat display unit 6R, 6L preferably with a wire. IN exemplary embodiments, when the Internet access of the mobile device 8 is requested from the head unit 2, the rear seat display unit 6R, 6L, or the mobile device 8, the network gateway 10 controls the mobile device 8 and the telematics module 4 so that the mobile device 8 may access to the Internet through the telematics module 4.

The mobile device which is applicable to the present invention preferably includes, but is not limited to, a notebook, a laptop, a portable multimedia player PMP, a portable game console, and a hand-held music player (IPod). In the embodiment exemplified in FIG. 1, the head unit 2 and the rear seat display unit 6R, 6L were separately illustrated. However, in other preferred embodiments, the user interface in which a user command is inputted and the processed result of the user command is indicated is synthetically designed or can be suitably implemented with one or more display units.

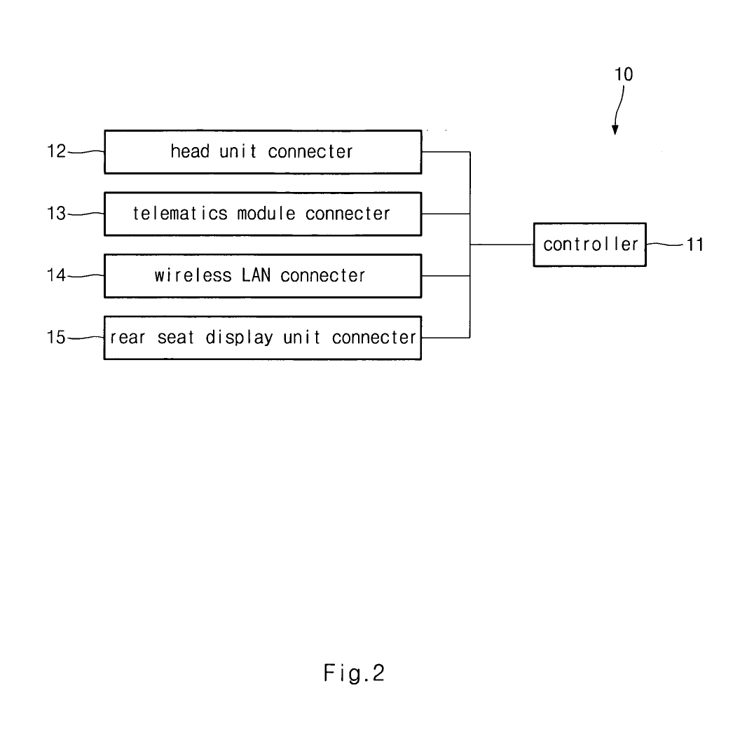

FIG. 2 is a detailed block diagram of the network gateway illustrated in FIG. 1.

As shown in FIG. 2, the network gateway 10 suitably includes a head unit connecter 12, a telematics module connecter 13, a wireless LAN connecter 14, a rear seat display unit connecter 15, and a controller 11.

The head unit connecter 12 is preferably connected to the head unit 2 through a wire and receives a command signal and an image signal transmitted from the head unit 2 with the low voltage differential signaling LVDS mode to transmit to the controller 11. It also preferably transmits the contents transmitted from the head unit 2 under the control of the controller 11 to the wireless LAN connecter 14 or the rear seat display unit connecter 15, so that to output the contents to the mobile device 8 or the rear seat display unit 6R, 6L.

In other further embodiments, the head unit connecter 12 includes a communications line that transmits an encoded image data which is transmitted from the wireless LAN connecter 14 to the head unit 2. In another embodiment of the present invention, the head unit connecter 12 can suitably receive the command signal for the Internet access of the mobile device 8 from the head unit 2.

The telematics module connecter 13 is suitably connected to the telematics module 4 and a USB line to communicate by the USB signaling mode (for example, USB 2.0), requesting the Internet access to the telematics module 4 under the control of the controller 11, and preferably providing the Internet data transmitted from the telematics module 4 to the wireless LAN connecter 14. The wireless LAN connecter 14 is preferably connected to the mobile device 8 with the wireless LAN (for example, the WiFi 802.11b protocol), so that the mobile device 8 can access to the Internet under the control of the controller 11. An antenna for performing the wireless LAN can be suitably installed in the printed circuit board PCB with the imbedded type.

The rear seat display unit connecter 15 is connected to the rear seat display unit 6R, 6L with a wire (for example, the giga bit Ethernet). In another embodiment of the present invention, the rear seat display unit connecter 15 suitably receives the command signal and the image signal transmitted from the rear seat display unit 6R, 6L to transmit to the controller 11.

In one embodiment of the present invention, the rear seat display unit 6R, 6L may be suitably implemented by a touch panel. In this example, the rear seat display connecter 15 may suitably receive the command signal and the image signal transmitted from the rear seat display unit 6R, 6L with the low voltage differential signaling mode. The controller 11 suitably controls the head unit connecter 12, the telematics module connecter 13, the wireless LAN connecter 14, and the rear seat display unit connecter 15 based on the command inputted from the head unit connecter 12, the wireless LAN connecter 14, or the rear seat display connecter 15, so that the mobile device 8 can connect to the Internet through the telematics module 4.

In one preferred embodiment of the present invention, the printed circuit board PCB in which the head unit connecter 12, the telematics module connecter 13, the wireless LAN connecter 14, the rear seat display unit connecter 15, and the controller 11 are preferably designed is installed at the internal space of the head unit 2 or the rear seat display unit 6R, 6L, so that it can be suitably manufactured as a single body with the head unit 2 or with the rear seat display unit 6R, 6L.

In another embodiment, the printed circuit board PCB in which the head unit connecter 12, the telematics module connecter 13, the wireless LAN connecter 14, the rear seat display unit connecter 15, and the controller 11 are preferably designed may be suitably manufactured as a single body with the telematics module 4.

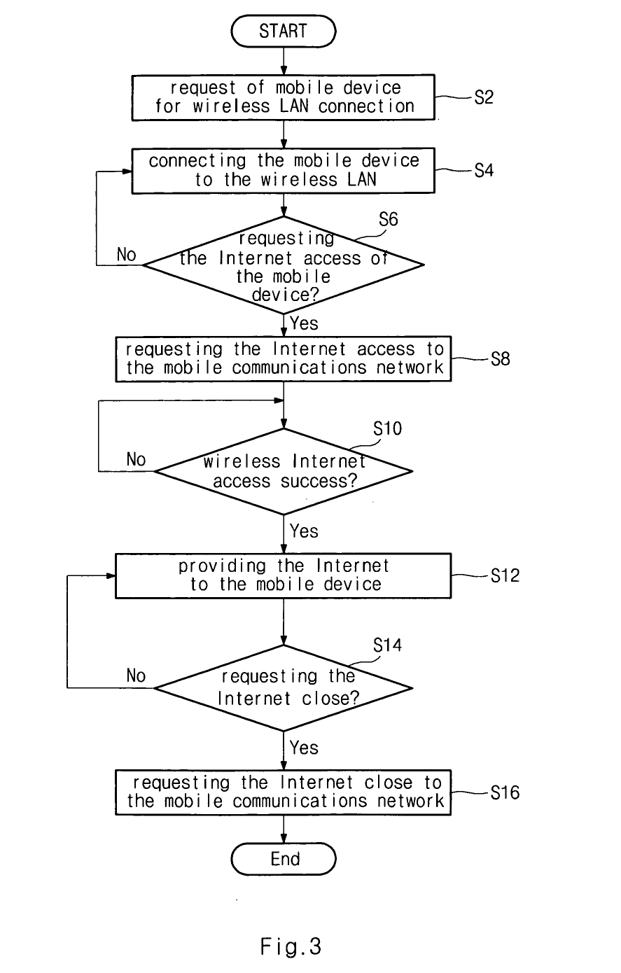

The operation of the network system for a vehicle according to an embodiment of the present invention will be illustrated in detail with reference to the attached flowchart illustrated in exemplary FIG. 3.

In one embodiment, the wireless LAN connection is suitably requested from the mobile device 8 (S2), the controller 11 assigns the radio channel to the mobile device 8 through the wireless LAN connecter 14 and connects the mobile device 8 to the wireless LAN (S4). In preferred embodiments, the Internet access of the mobile device 8 is suitably requested while the wireless LAN is connected through S2 and S4 (Yes in S6), the controller 11 suitably transmits an Internet access request control data to the telematics module 4 through the telematics module connecter 13 (S8).

In one preferred embodiment of the present invention, the Internet access request for the mobile device 8 is generated from the mobile device 8, the head unit 2, or the rear seat display unit 6R, 6L and may be received by the controller 11. In another preferred embodiment of the present invention, it is preferable that the program which can perform the Internet access and the Internet utilization through the telematics module 4 is stored in the mobile device 8, after suitably connecting to the telematics module 4 through the wireless LAN. The mobile device 8 can suitably request the Internet access through the telematics module 4 in user interface which is provided by the program while the program is activated.

In the meantime, in case the Internet access request control data is preferably received from the telematics module connecter 13 of the network gateway 10, the telematics module 4 preferably transmits an Internet access request message to the mobile communications network (not shown).

In case the radio channel is allocated from the mobile communications network and the Internet connection acknowledgement message is preferably transmitted in response to the Internet access request message, the telematics module 4 suitably becomes the state of succeeding in the Internet access. In case the telematics module 4 succeeds in the Internet access, it preferably notifies the Internet access success through the telematics module connecter 13 to the controller 11 of the network gateway 10.

Thus, according to exemplary embodiments, when the Internet access success is notified from the telematics module connecter 13 (Yes in S10), the controller 11 suitably controls the wireless LAN connecter 14 and the telematics module connecter 13, so that the data communications between the telematics module connecter 13 and the wireless LAN connecter 14 is suitably performed. Due to the data communications, the mobile device 8 is able to connect to the Internet which is suitably provided by the mobile communications network through the telematics module 4. Therefore, according to preferred embodiments, the mobile device 8 is able to freely use the Internet (S12).

According to preferred embodiments, the controller 11 transmits an Internet close request control data to the telematics module 4 preferably through the telematics module connecter 13 when the Internet close command is inputted (Yes in S14).

In another embodiment of the present invention, the Internet access request for the mobile device 8 is generated from the mobile device 8, the head unit 2, or the rear seat display unit 6R, 6L, and in further embodiments may be sent to the controller 11. The telematics module 4 which received the Internet close request control data suitably transmits the Internet close request message to the mobile communications network (S16). In further embodiments, the mobile communications network disconnects with the telematics module 4 based on the Internet close request message. Accordingly, in further preferred embodiments, the Internet access of the telematics module 4 is terminated.

As described herein, the network gateway for a vehicle according to certain embodiments of the present invention preferably has an effect that a mobile device supporting a wireless LAN can connect to an Internet through a telematics module of a vehicle without additional equipment.

What is claimed is:

1. A network gateway for a vehicle, comprising:
an interface connecter which is connected to an user interface in which a user command is inputted and a process result for the user command is indicated;
a telematics module connecter which is connected to a telematics module in which a mobile communications network connecter is mounted;
a wireless LAN connecter which is connected to a mobile device equipped with a wireless LAN; and
a controller which connects the mobile device to the Internet that the mobile communications network provides through the telematics module when the Internet access of the mobile device is requested from the interface connecter or the wireless LAN connecter.

2. The network gateway for a vehicle of claim 1, wherein a printed circuit board in which the interface connecter, the telematics module connecter, the wireless LAN connecter, and the controller are designed is installed at the inside of the user interface.

3. The network gateway for a vehicle of claim 1, wherein a printed circuit board in which the interface connecter, the telematics module connecter, the wireless LAN connecter, and the controller are designed is installed at the inside of the telematics module.

4. The network gateway for a vehicle of claim 1, wherein the controller requests the telematics module to perform the Internet access of the mobile device when the Internet access of the mobile device is requested, while the telematics module transmits an Internet access request message to the mobile communications network under the control of the controller to connect the mobile device to the Internet that the mobile communications network provides.

5. The network gateway for a vehicle of claim 1, wherein the controller requests the telematics module to perform an Internet close of the mobile device when the Internet close of the mobile device is requested, while the telematics module transmits an Internet close request message to the mobile communications network under the control of the controller to disconnect the mobile device to the Internet that the mobile communications network provides.

6. The network gateway for a vehicle of claim 4, wherein the controller requests the telematics module to perform an Internet close of the mobile device when the Internet close of the mobile device is requested, while the telematics module transmits the Internet close request message to the mobile communications network under the control of the controller to disconnect the mobile device to the Internet that the mobile communications network provides.

7. A network system for a vehicle, comprising:
an user interface which receives a user command and indicates a process result for the user command;
a telematics module in which a mobile communications network connecter is mounted to be able be connected to the Internet that the mobile communications network provides;
a mobile device equipped with a wireless LAN; and
a network gateway which connects the mobile device to the Internet that the mobile communications network provides through the telematics module according to the request of the user interface or the mobile device in the state of being connected to the mobile device through the wireless LAN.

8. The network system for a vehicle of claim 7, wherein the user interface is one or more display units which are installed at the inside of a vehicle and receive a given command from the user.

9. The network system for a vehicle of claim 7, wherein the mobile device loads a program for performing the Internet access while being linked with the network gateway in the state where the network gateway and the wireless LAN are connected.

10. The network system for a vehicle of claim 7, wherein the network gateway requests the Internet access of the mobile device to the telematics module when the Internet access of the mobile device is requested, while the telematics module transmits an Internet access request message to the mobile communications network under the control of the network gateway to connect the mobile device to the Internet.

11. The network system for a vehicle of claim 7, wherein the network gateway includes:
an interface connecter which is connected to the user interface;
a telematics module connecter which is connected to the telematics module;
a wireless LAN connecter which a mobile device is connected to through the wireless LAN; and
a controller which connects the mobile device to the Internet that the mobile communications network provides through the telematics module when the Internet access of the mobile device is requested from the interface connecter or the wireless LAN connecter.

12. A network gateway for a vehicle, comprising:
an interface connecter which is connected to an user interface in which a user command is inputted and a process result for the user command is indicated;
a telematics module connecter which is connected to a telematics module in which a mobile communications network connecter is mounted;
a wireless LAN connecter which is connected to a mobile device equipped with a wireless LAN; and
a controller which connects the mobile device to the Internet that the mobile communications network provides through the telematics module.

13. The network gateway for a vehicle of claim 23, wherein the controller connects the mobile device to the Internet that the mobile communications network provides through the telematics module when the Internet access of the mobile device is requested from the interface connecter or the wireless LAN connecter.

14. A motor vehicle comprising the network system of claim 1.

15. A motor vehicle comprising the network system of claim 12.
